(19) United States
(12) Patent Application Publication
(10) Pub. No.: US 2007/0151906 A1
(43) Pub. Date: Jul. 5, 2007

(54) Temperature pressure controlled flow rate

(76) Inventors: Markus Beer, Morsbach (DE); Michael Jacob, Morsbach (DE); Michael Dedering, Morsbach-Lichtenberg (DE); Wolfgang Stausberg, Morsbach (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/453,878

(22) Filed: Jun. 16, 2006

(30) Foreign Application Priority Data
Jun. 16, 2005 (DE) DE 102005027920.1

(51) Int. Cl. B01D 35/14

(52) U.S. Cl. 210/130

(57) ABSTRACT

The present invention relates to a filter device for filtering a fluid, in particular an oil filter. It has at least one filtering medium and a bypass for the filtering medium. Furthermore, an actuator is provided, which influences the flow of the fluid through the bypass as a function of a predetermined parameter of the fluid. The actuator is preferably controlled as a function of the viscosity of the fluid, a differential pressure of the fluid at the filtering medium, and/or the temperature of the fluid.

The present invention relates to a filter device for filtering a fluid, such as an oil filter, which has at least one filtering medium and a bypass for the filtering medium.

Implementing a suction-side oil filter for automatic transmissions using a fine-filtering filter medium and a bypass, which is provided with a coarse filter medium, is known from U.S. Pat. No. 4,402,827. At low temperatures, when the fluid is highly viscous, it may pass through the coarse filter medium and a pressure drop has little effect. At higher temperatures, when the fluid is low viscosity, it may pass through the fine filter medium, so that a higher filtration efficiency is achieved.

In such a system, however, a flow component through the coarse filter medium also arises even at higher temperatures, so that only a slight filtration of the fluid is achievable for this component. Because of the increasing requirements in automatic transmissions or in internal combustion engines in regard to high filtration performance, however, it is necessary to provide a pressure-side oil filter, which is typically provided with an extremely fine filter medium, in addition to a suction-side oil filter, so that it is possible to achieve high filtration performance. However, it has been shown that such a combination made of two filters may be relatively complex and costly.

It is therefore an object of the present invention to provide a filter device for filtering a fluid which has such a high filtration efficiency and such a high contaminant absorption capacity that the service life of a pressure-side oil filter and/or its replacement intervals may be significantly extended or the use of a pressure-side oil filter is no longer necessary at all. Furthermore, it is an object of the present invention to provide a filter device for filtering a fluid which may at least partially clean itself. This object is achieved according to the present invention in that the filter device has an actuator which influences the flow of the fluid through the bypass as a function of a predetermined parameter of the fluid.

It is thus possible at higher fluid temperatures, for example, to have the fluid to be filtered only pass through the filtering medium, while no volume flow passes through the bypass. The pressure drop thus remains relatively low at higher fluid temperatures, while a high filtration efficiency is achieved. At low fluid temperatures, the bypass may be released using the actuator and there may be flow through it, while because of the relatively high viscosity of the fluid, only a smaller volume flow passes through the filtering medium. A higher filtration efficiency may thus be achieved by the actuator.

According to a preferred embodiment of the present invention, the actuator is controllable as a function of a manipulated variable. In principle, this may be any variable for influencing an actuator in its function A differential pressure between the inflow side and the outflow side of the filtering medium which the fluid may flow through or a temperature of the fluid is preferably suitable as the manipulated variable. This is because the viscosity of the fluid is strongly dependent on temperature and causes a corresponding differential pressure at the filter medium. For example, at a relatively low temperature of −40° C., the viscosity of a fluid may be so high that almost no fluid passes through a fine-filtering filter medium.

In the filter device according to the present invention, the actuator preferably comprises a flap or a slide or a valve. Components of this type allow mechanical diversion of the volume flow in a simple way. The positioning of the actuator in a location in which the coarse-filtering medium has fluid flow through it completely, only still partially, or not at all anymore may be performed in such a way that the actuator is held spring-loaded. Through a spring-loaded holder, a contact pressure force on the actuator is predefined, against which a force due to the volume flow of the fluid acts. With high viscosity fluid, the spring-loaded actuator is pressed far back, for example, while a low viscosity fluid may only apply a slight force against the actuator. It is also possible to implement the actuator itself as springy. A spring-loaded holder may thus be saved, so that the actuator only has one component. An actuator made of a temperature-sensitive material which changes its geometry in a predetermined way upon exceeding a boundary temperature (e.g., memory metal is preferred. To further increase the filtration performance, it is advantageous for the actuator to be implemented as a further filtering medium whose permeability is designed for low viscosity. At lower viscosity, it acts like the other filter medium so that no filtering area is lost. At higher viscosity, it releases the bypass.

In a preferred embodiment of the present invention, the finer filtering medium is an extremely fine-filtering medium A high filtration performance is thus achieved with low viscosity fluid. If the coarse-filtering medium and the extremely fine-filtering medium are situated in parallel to one another, a high viscosity fluid may be conducted through the coarse-filtering medium, during an engine start, for example. If the temperature rises and the viscosity correspondingly falls, an increasingly higher proportion of the fluid may flow through the extremely fine filter medium, so that the filtration performance is continuously increased If a fine filter medium is connected in series to the extremely fine filter medium, the filtration performance may be increased even further. Low viscosity fluid then first passes a fine filter medium in which contaminant particles are filtered out finely, before this filtered fluid subsequently passes an extremely fine filter medium, in which extremely fine filtration occurs.

According to a further embodiment of the present invention, the finer filtering medium is a fine filter medium, while the coarse-filtering medium and the fine filter medium are situated in series to one another. Therefore, at low fluid temperatures, at least the filtration performance of a typical suction-side oil filter is achieved. At higher temperatures, the filtration performance may be increased in that an extremely fine filter medium is situated in series to the fine filter medium. The fluid to be filtered thus flows through both a fine filter medium and also an extremely fine filter medium. If the coarse-filtering medium and the extremely fine filter medium are situated in parallel to one another, at low temperatures, the coarse-filtering medium may allow a large flow component to flow through it, while at increasing temperatures, the actuator suppresses the fluid passage through the coarse-filtering medium more and more strongly until the fluid only still passes through the fine filter medium and the extremely fine filter medium. Therefore, the filtration performance of a typically combined filter system made of suction-side oil filter and downstream pressure-side oil filter may be achieved by only one filter device.

The extremely fine filter medium preferably allows particles having a size of less than 5 μm through. The filtration performance of a pressure-side oil filter may thus be achieved. If the fine filter medium allows particles having a size of less than 50 μm through, the filtration performance of a standard filter medium is achieved by this filter medium alone.

If the filtering medium is implemented as a single-layer fluid filter medium, only relatively few aspects are to be considered during a replacement procedure of a filter medium of this type, so that the procedure may be performed with relatively few complications.

At least one filtering medium which is implemented as a pleated fluid filter medium is preferably used in the filter device. This allows a significant increase of the active filtration area at identical or nearly identical overall size of the filter device, so that even higher filtration performance may be achieved. A pleated filter medium may be a filter pocket which is folded once, for example. However, the pleated filter medium may also be folded multiple times, so that filter media connected in parallel may have flow through them.

The filter device according to the present invention is usable in an automatic transmission of a motor vehicle. This is advantageous since thus a higher efficiency, a higher performance capability, and a higher shifting comfort may be achieved in an automatic transmission.

According to a further embodiment of the present invention, the filter device is usable in an engine of a motor vehicle. Since, in the motor vehicle, particles such as combustion residues, abraded metal, dust, etc. in the lubricant loop result in damage, these effects may be significantly reduced through use of the filter device according to the present invention.

Furthermore, the filter device according to the present invention may be used in a suction-side filter and/or a pressure-side filter. Such use is advantageous since such a high filtration performance may be achieved through the filter device according to the present invention, with low pressure drop at the filter medium at the same time, that a pressure-side oil filter may be replaced by a suction-side oil filter.

Furthermore, a filter having a filter device as described above is provided according to the present invention.

In the following, the present invention will be explained in greater detail on the basis of preferred embodiments with reference to the drawing.

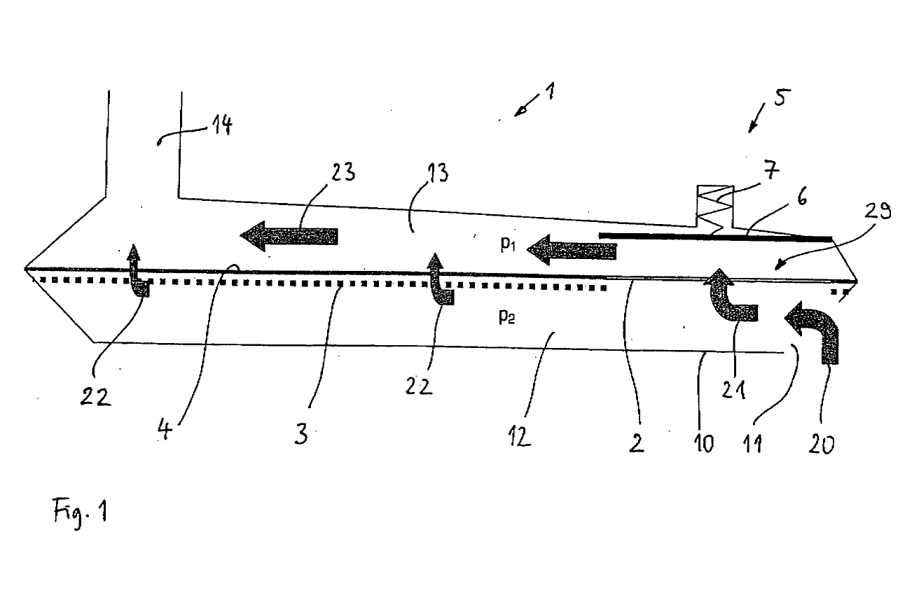

FIG. 1 shows a schematic cross-sectional view of a first embodiment of the filter device according to the present invention in the cold state,

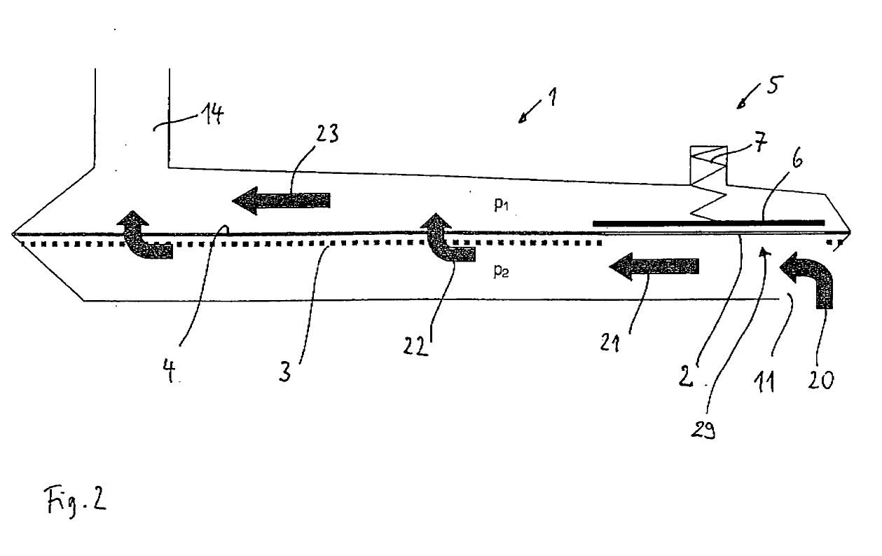

FIG. 2 shows a schematic cross-sectional view of a first embodiment of the filter device according to the present invention in the hot state,

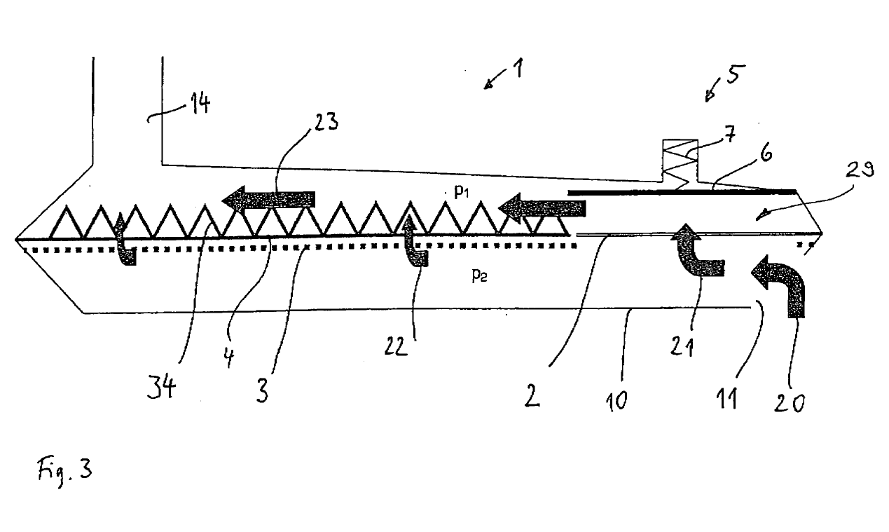

FIG. 3 shows a schematic cross-sectional view of a second embodiment of the filter device according to the present invention in the cold state,

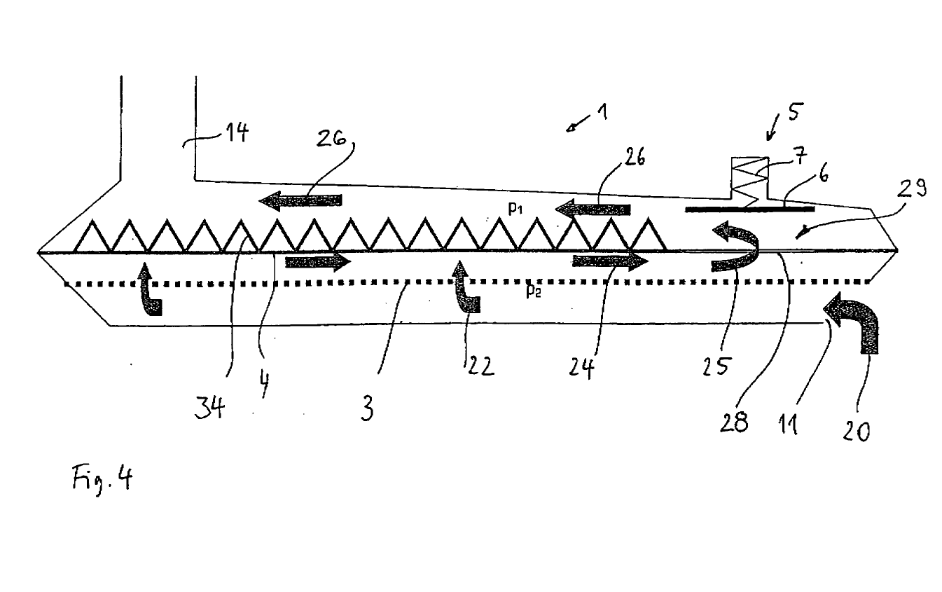

FIG. 4 shows a schematic cross-sectional view of a third embodiment of the filter device according to the present invention in the cold state,

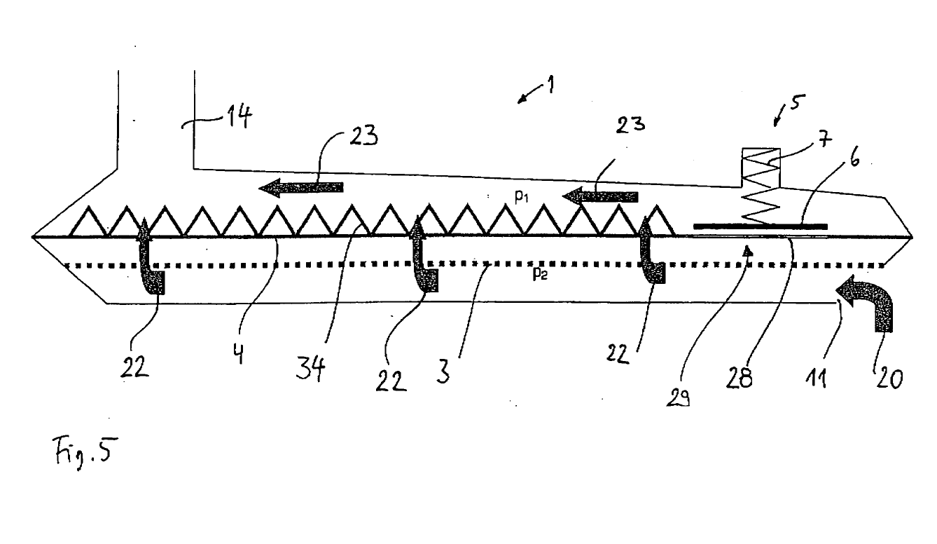

FIG. 5 shows a schematic cross-sectional view of a third embodiment of the filter device according to the present invention in the hot state,

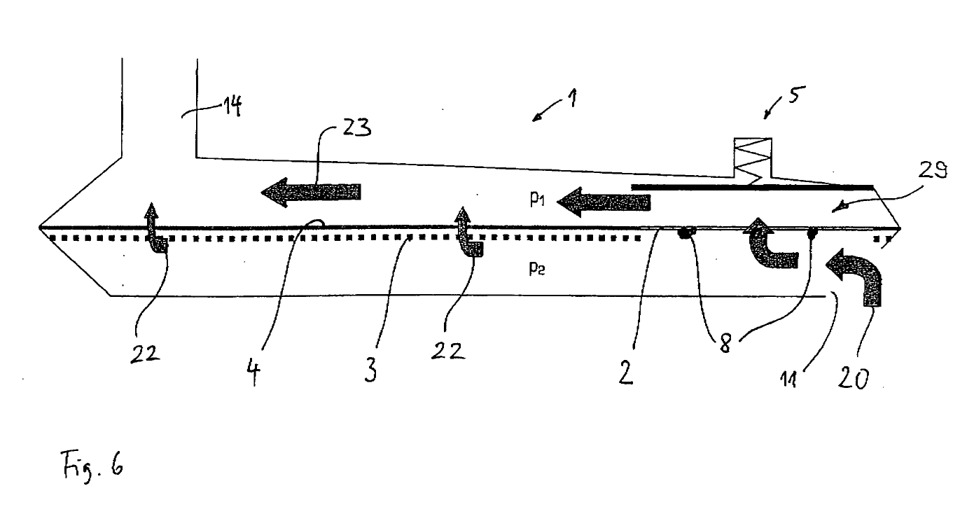

FIG. 6 shows a schematic cross-sectional view of the first embodiment of the filter device according to the present invention in the cold state having particles received on a filter medium,

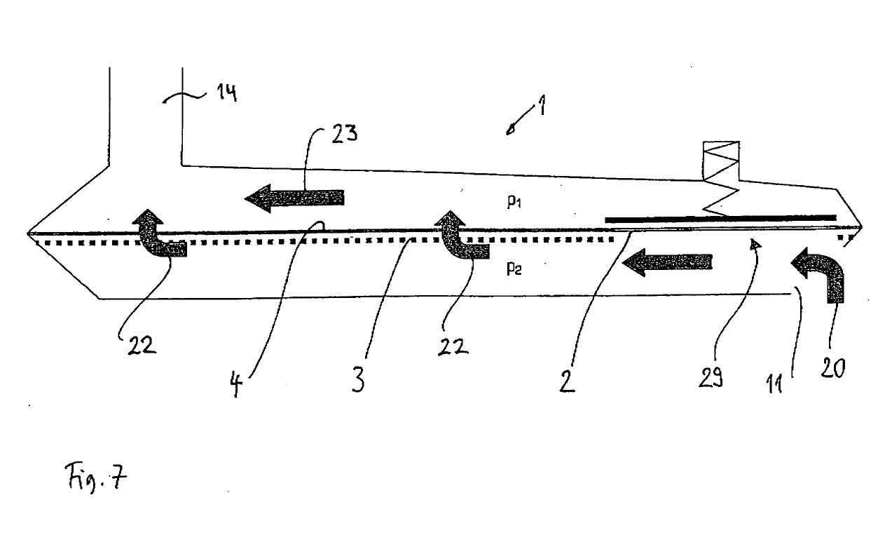

FIG. 7 shows a schematic cross-sectional view of the first embodiment of the filter device according to the present invention in the hot state having particles no longer present on a filter medium,

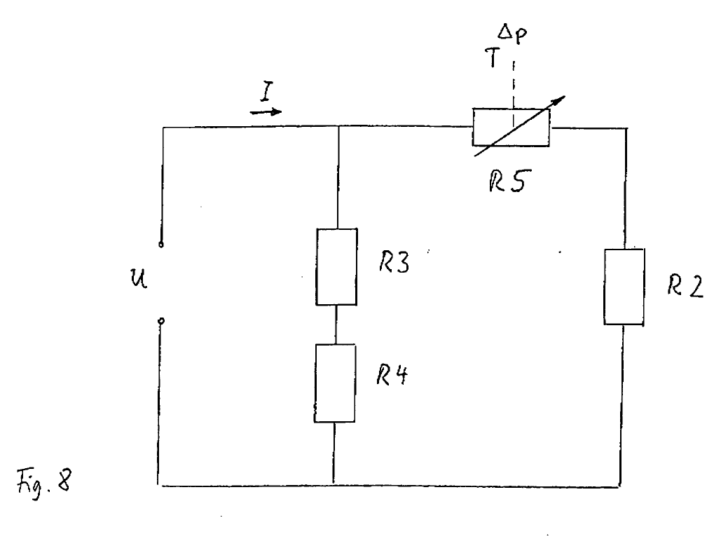

FIG. 8 shows a schematic illustration of the volume flow for the first and second embodiments of the filter device according to the present invention, and

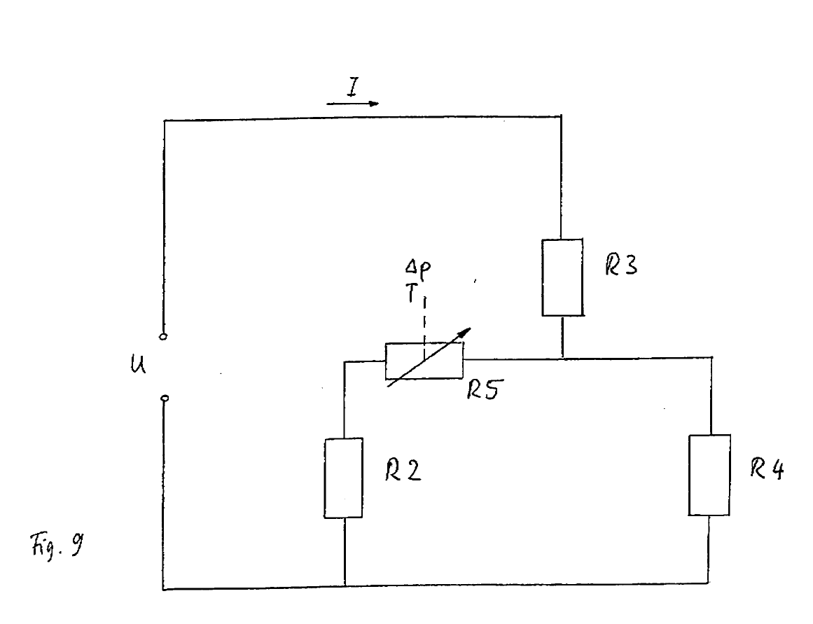

FIG. 9 shows a schematic illustration of the volume flow for the third embodiment of the filter device according to the present invention.

Identical reference numerals are used for identical parts in the figures.

FIG. 1 shows a schematic cross-sectional view of a first embodiment of a filter device 1, implemented as an oil filter, having a filter housing 10 and an inlet 11 and an outlet 14 for a fluid flowing through the filter device 1. In the filter device 1, a filter medium having a bypass 29 is provided between inlet 11 and outlet 14. The filter medium has a first filter medium 4 in the form of an extremely fine filter. The bypass 29 is provided with a second filter medium 2, which is implemented as a coarse filter. Optionally, a third filter medium 3 in the form of a fine filter may be situated as a prefilter in the flow direction in front of the first filter medium.

To regulate the volume flow through the bypass 29, an actuator 5 is provided, which has a plate 6 as a blocking body and a spring 7 as the control element, The spring 7 is coupled to the plate 6 in such a way that the plate 6 is pressed in the direction toward the coarse-filtering second filter medium 2 against the flow direction of the fluid. The spring force forms the manipulated variable. The plate 6 may be impermeable, so that it may close the bypass 29 tightly. Alternatively, the plate may also be implemented as a fine filter medium or as an extremely fine filter medium, so that the bypass 29 is covered by a fine filter medium or an extremely fine filter medium when actuator 5 is closed.

The second, third, and first filter media 2, 3, and 4 are essentially placed in the vertical center of the filter housing 10 such a way that a first zone 12 on the inflow side of the filter media and a second zone 13 on outflow side of the filter media are provided. The actuator 5 is provided here in the downstream zone of the filter housing 10. It is placed in such a way that a partial volume flow 21 of the fluid volume flow 20 conducted into the inlet of the filter housing may act against a contact pressure force of the spring 7 in the direction toward the coarse-filtering medium 2. It is thus possible that at cold fluid temperatures, a correspondingly highly viscous fluid may oppose the actuator 5 and/or the spring 7 with a pressure force which is so great that the plate 6 of the actuator 5 releases the bypass 29. The flow component 21 flowing through the bypass 29 thus reaches the second zone 13 (inflow side) of the filter housing 10 and flows along the first filter medium 4 (extremely fine filter) as shown by arrow 23 in the direction toward the outlet 14 of the filter housing 10.

Another flow component 22 may pass through the third and first filter media 3 and 4, which are connected in series. At low fluid temperatures, the viscosity is so high, however, that the flow component 22 passing through is significantly less than the flow component 21 flowing through the bypass 29. Through such a system, a parallel circuit of coarse-filtering medium on one side and fine-filtering medium and extremely fine-filtering medium on the other side is achieved. The pressure drop p2-p1 at the filter medium shown in FIG. 1 may thus be kept small overall even at low temperatures of the fluid. This avoids a high viscosity fluid having to flow through a fine filter medium and an extremely fine filter medium, which would result in a significant pressure drop at these filter media because of the lower viscosity.

In the hot state of the fluid, a situation results as is schematically shown in FIG. 2. A low viscosity fluid is no longer capable of applying sufficient counterforce against the contact pressure force applied by the spring 7 in the direction toward the bypass 29. A situation is thus achieved in which the plate 6 closes the bypass 29 and a volume flow of the fluid may no longer flow through it. The fluid volume flow 20 entering the filter device 10 then corresponds to the fluid volume flow 21 through the bypass 29.

As may be seen from FIG. 2, in the hot state of the fluid, the entire volume flow thus first passes through the third filter medium 3 (extremely fine filter) and subsequently through the first filter medium 4 (extremely fine filter). Thus, two advantages are coupled to one another in this embodiment of the filter device: in the cold state of the fluid, a lower pressure drop at the filter medium is provided with adequate filtration performance, while in the hot state of the fluid, which represents the normal operating state, there is also a low pressure drop at the filter medium, with even better filtration performance.

A second embodiment of the present invention, analogous to FIG. 1, is schematically illustrated in FIG. 3. In contrast to the first embodiment, the first filter medium 4 (extremely fine filter) is implemented using a pleated filter 34 made of extremely fine filter so that a larger filter area is achieved. It is thus possible to achieved even better filtration performance. The extremely fine filter medium of the first filter medium 4 and the pleated filter 34 may be implemented in such a way that it has no support surface on the bottom and rests directly on the third filter medium 3 (extremely fine filter). However, the intrinsic stability of the third and first filter media 3, 4 may be elevated overall using support material.

Using the pleated filter 34 implemented as the extremely fine filter, a filter area is provided which is typically only present in a pressure-side oil filter. If such an embodiment is used in a suction-side oil filter, either the replacement intervals for replacing a fluid filter medium in a pressure-side oil filter may be lengthened or a pressure-side oil filter may become completely superfluous. In general, the object of allowing a filtration performance in the filter device according to the present invention as in a combination of typical suction-side filter and pressure-side filter is achieved all the more when the area ratios of the filter media used correspond to those in the combination made of suction-side filter and pressure-side filter.

FIGS. 4 and 5 show a third embodiment according to the present invention. A fine filter medium 3 is situated in such a way for this purpose that it covers the entire cross-sectional area of the filter device. A fluid volume flow 20 enters the filter device 1 at the inlet 11 and flows through the third filter medium 3 (extremely fine filter). A first filter medium 4 (extremely fine filter), which, as in the first or second embodiment of the present invention covers only a part of the cross-sectional area of the filter device 1, is situated at a distance to the third filter medium 3 above the third filter medium 3. The other part of the cross-sectional area neighboring thereto is preferably implemented as a filter-free passage 28. The actuator 5 having a plate 6 and a spring 7 is provided above the coarse-filtering second filter medium 2.

In the cold state of the fluid, as shown in FIG. 4, the fluid volume flow 20 passes completely through the fine filter medium 3 as shown by the arrow 22 and flows, see arrow 24, along the fine filter medium in the direction toward the coarse-filtering second filter medium 2, since this has a much lower flow resistance than the first filter medium 4 and the pleated filter 34. The fluid volume flow passes the coarse-filtering second filter medium 2 as shown by arrow 25 and flows essentially above the first filter medium 4 (extremely fine filter) in the direction to the outlet 14, see arrow 26.

In the cold state of the fluid, a situation is thus achieved as is provided in typical suction-side oil filters. In the hot state of the fluid, the coarse-filtering second filter medium 2 is covered by the plate 6 as shown by FIG. 5, so that no fluid volume flow may still pass through there. The entire volume flow 22 passes through the third filter medium 3 (extremely fine filter) and subsequently through the first filter medium 4 (extremely fine filter) and then flows above the first filter medium 4 as shown by arrow 23 to the outlet 14. A lesser fluid secondary flow may also flow through the front face of the laterally open pleated extremely fine filter medium.

In this embodiment of the present invention as well, a relatively low pressure drop is thus achieved in the cold state of the fluid with good filtration performance, while at higher temperature of the fluid, a very low pressure drop is possible with very good filtration performance because of the lower viscosity.

The transition between cold fluid state and hot fluid state does not occur abruptly in the filter devices described above, but rather continuously. This means that the plate 6 of the actuator 5 does not act like a switch, which switches between “on” and “off”. Rather, the plate 6 approaches the coarse-filtering second filter medium 2 more and more with increasing temperature of the fluid, until it may completely cover the coarse-filtering second filter medium 2 and/or the passage 28 in its final position. Before this final position is reached, a secondary effect occurs, which is significant for the self-cleaning of the coarse-filtering second filter medium 2, as described in the following.

In the first exemplary embodiment from FIG. 1 and FIG. 2, the coarse-filtering second filter medium 2 is cleaned automatically of accumulated particles 8 upon closure of the bypass through the Bernoulli effect (FIG. 6), so that a possibly existing low contaminant absorption capacity is irrelevant. The service life of the filter device according to the present invention is thus significantly increased. The cleaned filter device is shown in FIG. 7.

The system of the filter medium 2, 3, and 4 according to the filter device according to the present invention may be shown schematically as in FIGS. 8 and 9. FIG. 8 shows an electric resistor network having the resistors R2, R3, R4, and R5, through which a current I flows, which is driven by a voltage source U. The voltage source represents the partial vacuum generated by a pump in this case, the pump causing a fluid volume flow to be guided through the filter media 2, 3, and 4. The filter media have an associated resistor R2, R3, and R4. The resistor R5 is shown as a variable resistor and represents the actuator 5, which allows or does not allow the fluid volume flow through the coarse-filtering second filter medium 2, represented by the resistor R2, as a function of the differential pressure at the filter medium or the temperature of the fluid.

The fluid volume flow is divided between the resistors R2 and (R3+R4), which are connected in parallel, depending on its size. In the cold state of the fluid, the largest component of the fluid flows through the smallest resistor, in this case R2. Only a small component of the fluid flows through the resistors R3+R4. In the hot state of the fluid, passage through the coarse-filtering second filter medium 2 is no longer possible, so that R5 may be viewed as infinite. The flow resistance of the fluid is thus only still formed by R3+R4.

In the third embodiment of the present invention, see FIGS. 4 and 5, the circuit of the filter media is implemented differently, see FIG. 9. The entire fluid volume flow passes through the third filter medium 3 (extremely fine filter), represented by R3 in FIG. 9. Depending on the temperature of the fluid or differential pressure at the filter medium, represented by the variable resistor R5, the fluid then flows either through the coarse-filtering second filter medium 2, represented by R2, or the extremely fine filter medium 4, represented by R4. There is thus a parallel circuit of the resistors R2 and R4, to which the resistor R3 is connected in series downstream.

In principle, other circuits of the resistors R2, R3, R4, and R5 in combination with single-layer filters, pleated filters, or pocket filters are also conceivable in the scope of the present invention, in order to achieve both a high filtration performance and also a low pressure drop at the filter media using only one suction-side filter.

1. A filter device for filtering a fluid, such as an oil filter, which has at least one first filtering medium (4) and a bypass (29) for the first filtering medium (4), characterized in that the filter device (1) has an actuator (5), which influences the flow of the fluid through the bypass (29) as a function of a predetermined parameter of the fluid.

2. The filter device according to claim 1,
characterized in that the actuator (5) is influenced as a function of the viscosity of the fluid, a differential pressure of the fluid at the first filtering medium (4), and/or the temperature of the fluid.

3. The filter device according to claim 1 or 2,
characterized in that the actuator (5) is implemented as a flap, slider, or valve.

4. The filter device according to claim 3,
characterized in that the actuator (5) is linked to or displaceably guided on a housing (10) of the filter device (1).

5. The filter device according to one of claims 1 through 4,
characterized in that the actuator (5) has a spring (7) applied to it against the flow direction of the fluid, the spring (7) forms the actuating element of the actuator (5), and the spring force predefines the manipulated variable of the actuator (5).

6. The filter device according to claim 5,
characterized in that the spring (7) has temperature-dependent spring properties.

7. The filter device according to one of claims 1 or 2,
characterized in that the actuator (5) is implemented as elastic and the elasticity of the actuator (5) predefines the manipulated variable.

8. The filter device according to claim 6,
characterized in that the actuator (5) is implemented as an elastic film, which is situated over the bypass (29) in such a way that it covers the bypass (29) under a predefined pressure load, and yields under elevated pressure load and releases a passage for the fluid.

9. The filter device according to one of the preceding claims,
characterized in that the actuator (5) is implemented as a further filtering medium, whose permeability is designed for low viscosity, and preferably corresponds to the first filtering medium (4).

10. The filter device according to one of the preceding claims,
characterized in that the bypass (29) has a second filtering medium (2), whose permeability is greater than the permeability of the first filtering medium (4).

11. The filter device according to claim 10,
characterized in that a third filtering medium (3), whose permeability is greater than the permeability of the first filter medium (4) and less than the permeability of the second filter medium (2), is situated in front of the first filtering medium (4).

12. The filter device according to one of claims 1 through 10,
characterized in that the second filter medium (2), which is more permeable than the first filtering medium (4), is situated in the flow direction in front of the first filtering medium (4) and the bypass (29) and distal thereto, and the bypass (29) is implemented as a filter-free passage.

13. The filter device according to one of the preceding claims,
characterized in that the first filtering medium (4) has a pleated filter (34).

14. The filter device according to one of the preceding claims,
characterized in that the filter device (1) is usable in an automatic transmission of a motor vehicle.

15. The filter device according to one of the preceding claims,
characterized in that the filter device (1) is usable in a suction-side filter and/or a pressure-side filter.

16. A method for filtering oil in an oil sump,
characterized in that at least one of the parameters of viscosity, pressure, and/or temperature of the oil is used for regulating a bypass lying parallel to a filter medium.
